(19) United States
(12) Patent Application Publication
(10) Pub. No.: US 2019/0234991 A1
(43) Pub. Date: Aug. 1, 2019

(54) PHYSICAL QUANTITY SENSOR, PHYSICAL QUANTITY SENSOR DEVICE, ELECTRONIC DEVICE, AND VEHICLE

(71) Applicant: Seiko Epson Corporation, Tokyo (JP)

(72) Inventor: Ryuji KIHARA, Matsumoto (JP)

(21) Appl. No.: 16/261,837

(22) Filed: Jan. 30, 2019

(30) Foreign Application Priority Data
Jan. 31, 2018 (JP) 2018-015763

(51) Int. Cl. G01P 15/125

(52) U.S. Cl. CPC G01P 15/125

(57) ABSTRACT

A physical quantity sensor includes a substrate, an element assembly, a fixed portion fixed to the substrate, a movable member that is displaced with respect to the fixed portion, a beam connecting the fixed portion and the movable member, and a structure that is fixed to the substrate. The structure has a first structure in which the first structure and the movable member are arranged in a first direction with a first gap therebetween, and a second structure in which the second structure and the movable member are arranged in a second direction orthogonal to the first and a third direction with a second gap larger than the first gap therebetween. A spring constant of the beam when the movable member is displaced around an axis along a third direction is smaller than a spring constant of the beam when the movable member is displaced in the first direction.

The entire disclosure of Japanese Patent Application No. 2018-015763 filed Jan. 31, 2018, is expressly incorporated by reference herein.

### BACKGROUND

### 1. Technical Field

The present disclosure relates to a physical quantity sensor, a physical quantity sensor device, an electronic device, and a vehicle.

### 2. Related Art

For example, an acceleration sensor described in JP-A-11-230985 includes a substrate, a fixed portion fixed to the substrate, a movable member connected to the fixed portion via a beam, a movable detection electrode provided on the movable member, a fixed detection electrode fixed to the substrate and forming an electrostatic capacitance with the movable detection electrode. With such a configuration, when acceleration is applied, the movable member is displaced with respect to the substrate while elastically deforming the beam, and the electrostatic capacitance between the movable detection electrode and the fixed detection electrode is displaced accordingly. Therefore, it is possible to detect the acceleration based on the change in the electrostatic capacitance.

In addition, the acceleration sensor described in JP-A-11-230985 has a stopper for regulating excessive displacement of the movable member, and as the movable member (beam) contacts the stopper, further displacement of the movable member is prevented. In addition, the movable member is prevented from sticking to the stopper (occurrence of sticking) at the time of contact by setting the stopper to have the same potential as that of the movable member.

However, in the acceleration sensor described in JP-A-11-230985, it is possible to regulate excessive displacement (that is, detection vibration of excessive amplitude) of the movable member only in a detection axis direction by the stopper. The movable member may be displaced in a direction other than the detection axis direction, and if such unnecessary displacement occurs, the detection accuracy of the acceleration may decrease. In addition, it is preferable that the gap between the stopper and the movable member is as narrow as possible within a range that does not hinder the displacement of the movable member, but if the gap is narrowed, the burden at the time of manufacturing (etching process) will increase.

### SUMMARY

An advantage of some aspects of the present disclosure is to provide a physical quantity sensor, a physical quantity sensor device, an electronic device, and a vehicle that can suppress displacement different from the detection vibration and reduce a manufacturing load.

The present disclosure can be implemented as the following aspects.

A physical quantity sensor according to an aspect of the present disclosure includes a substrate, an element assembly having a fixed portion that is fixed to the substrate, a movable member that is capable of being displaced with respect to the fixed portion, and a beam that connects the fixed portion and the movable member, and a structure body that is located on a periphery of the movable member in a plan view in a normal direction to the substrate, in which the structure body includes a first structure body in which the first structure body and the movable member are arranged in a first direction and are provided on the substrate with a first gap therebetween, in the plan view and a second structure body in which the second structure body and the movable member are arranged in a second direction orthogonal to the first direction and are provided on the substrate with a second gap larger than the first gap therebetween, in the plan view, and a spring constant of the beam when the movable member is displaced around an axis along a third direction orthogonal to each of the first direction and the second direction is smaller than a spring constant of the beam when the movable member is displaced in the first direction.

With this configuration, it is possible to provide a physical quantity sensor capable of suppressing displacement different from a detection vibration and reducing a manufacturing load.

A physical quantity sensor according to an aspect of the present disclosure includes a substrate, an element assembly having a fixed portion that is fixed to the substrate, a movable member that is capable of being displaced with respect to the fixed portion, and a beam that connects the fixed portion and the movable member, and a structure body that is located on a periphery of the movable member in a plan view in a normal direction to the substrate, in which the structure body includes a first structure body in which the first structure body and movable member are arranged in a first direction and are provided on the substrate with a first gap therebetween, in the plan view and a second structure body in which the second structure body and the movable member are arranged in a second direction orthogonal to the first direction and are provided on the substrate with a second gap larger than the first gap therebetween, in the plan view, and the element assembly has a first vibration mode that vibrates around an axis along a third direction orthogonal to each of the first direction and the second direction and a second vibration mode that vibrates in the first direction and has a resonance frequency higher than the first vibration mode.

With this configuration, it is possible to provide a physical quantity sensor capable of suppressing displacement different from a detection vibration and reducing a manufacturing load.

In the physical quantity sensor according to the aspect of the present disclosure, it is preferable that the movable member includes a first movable member that is located on one side and a second movable member that is located on the other side with a swing axis interposed therebetween, the second movable member having a rotational moment around the swing axis different from a rotational moment around the swing axis of the first movable member, the physical quantity sensor further includes a first fixed electrode that is disposed on the substrate and opposed to the first movable member, and a second fixed electrode that is disposed on the substrate and opposed to the second movable member, and when an acceleration in the normal direction to the substrate is applied, the movable member is configured to swing around the swing axis while torsionally deforming the beam.

With this configuration, it is possible to detect the acceleration in the third direction based on the change in the electrostatic capacitance between the first movable member and the first fixed electrode and the electrostatic capacitance between the second movable member and the second fixed electrode. In addition, with such a configuration, while the detection vibration is a vibration outside the plane of the movable member, the first vibration mode and the second vibration mode are vibrations into the plane of the movable member. Therefore, only the unnecessary vibration may be effectively regulated by the first structure body and the second structure body arranged on the periphery of the movable member without hindering the detection vibration.

In the physical quantity sensor according to the aspect of the present disclosure, it is preferable that the first structure body is provided on both sides of the movable member in the first direction.

With this configuration, it is possible to regulate the displacement of both sides of the movable member in the first direction and effectively regulate the displacement of the movable member in the second vibration mode.

In the physical quantity sensor according to the aspect of the present disclosure, it is preferable that the second structure body is provided on both sides of the movable member in the second direction.

With this configuration, it is possible to regulate the displacement of both sides of the movable member around the axis and effectively regulate the displacement of the movable member in the first vibration mode.

In the physical quantity sensor according to the aspect of the present disclosure, it is preferable that at least one of the first structure body and the second structure body has the same potential as the movable member.

With this configuration, an electrostatic attractive force is generated between the movable member and the first structure body and between the movable member and the second structure body, and it is possible to suppress unintended displacement of the movable member. Therefore, it is possible to detect a physical quantity more accurately.

A physical quantity sensor device according to an aspect of the present disclosure includes the physical quantity sensor according to the aspect of the present disclosure and a circuit element that is electrically connected to the physical quantity sensor.

With this configuration, it is possible to obtain the effect of the physical quantity sensor of this disclosure and to obtain the physical quantity sensor device with high reliability.

An electronic device according to an aspect of the present disclosure includes the physical quantity sensor according to the aspect of the present disclosure and a control unit that performs control based on a detection signal output from the physical quantity sensor.

With this configuration, it is possible to obtain the effect of the physical quantity sensor according to the aspect of the present disclosure and to obtain the electronic device with high reliability.

vehicle according to an aspect of the present disclosure includes the physical quantity sensor according to the aspect of the present disclosure and a control unit that performs control based on a detection signal output from the physical quantity sensor.

With this configuration, it is possible to obtain the effect of the physical quantity sensor according to the aspect of the present disclosure and to obtain the vehicle with high reliability.

### BRIEF DESCRIPTION OF THE DRAWINGS

The present disclosure will be described with reference to the accompanying drawings, wherein like numbers reference like elements.

FIG. 1 is a plan view showing a physical quantity sensor according to a first embodiment.

FIG. 2 is a cross-sectional view taken along the line A-A in FIG. 1.

FIG. 3 is a diagram showing a voltage applied to the physical quantity sensor shown in FIG. 1.

FIG. 4 is a plan view showing a torsional vibration mode of an element assembly shown in FIG. 1.

FIG. 5 is a plan view showing an X-axis vibration mode of the element assembly shown in FIG. 1.

FIG. 6 is a plan view showing a modification example of a displacement regulating portion.

FIG. 7 is a plan view showing a modification example of the displacement regulating portion.

FIG. 8 is a cross-sectional view showing a method of manufacturing the element assembly shown in FIG. 1.

FIG. 9 is a cross-sectional view showing a method of manufacturing the element assembly shown in FIG. 1.

FIG. 10 is a cross-sectional view showing a method of manufacturing the element assembly shown in FIG. 1.

FIG. 11 is a cross-sectional view showing a physical quantity sensor device according to a second embodiment.

FIG. 12 is a perspective view showing an electronic device according to a third embodiment.

FIG. 13 is a perspective view showing an electronic device according to a fourth embodiment.

FIG. 14 is a perspective view showing an electronic device according to a fifth embodiment.

FIG. 15 is a perspective view showing a vehicle according to a sixth embodiment.

### DESCRIPTION OF EXEMPLARY EMBODIMENTS

Hereinafter, a physical quantity sensor, a physical quantity sensor device, an electronic device, and a vehicle according to the present disclosure will be described in detail based on embodiments shown in the accompanying drawings.

### First Embodiment

First, a physical quantity sensor according to a first embodiment will be described.

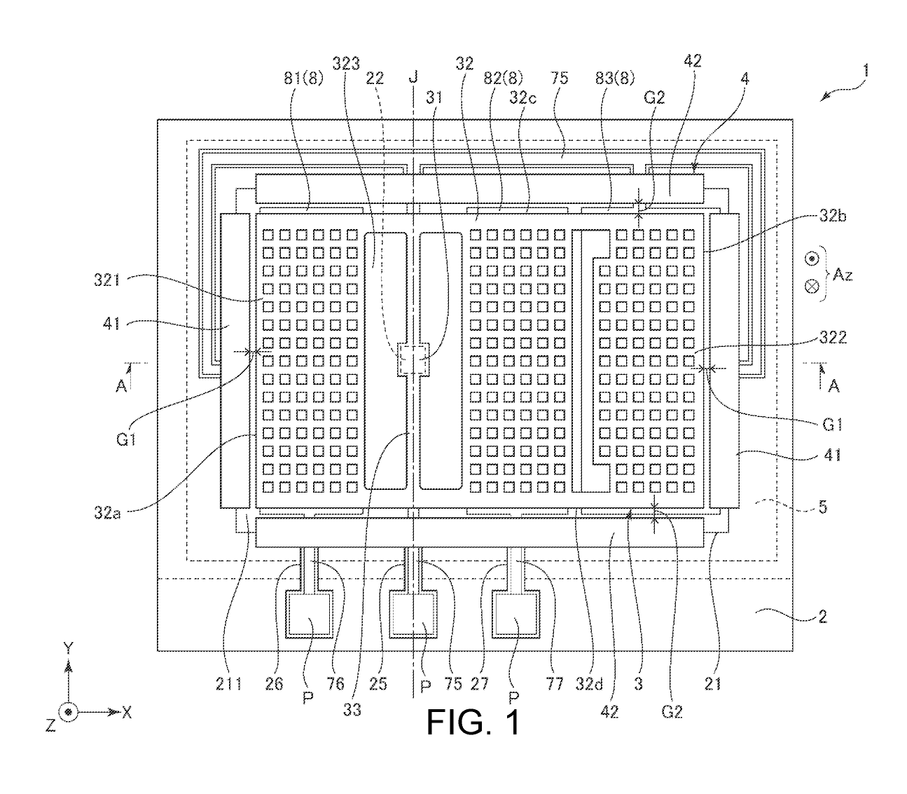

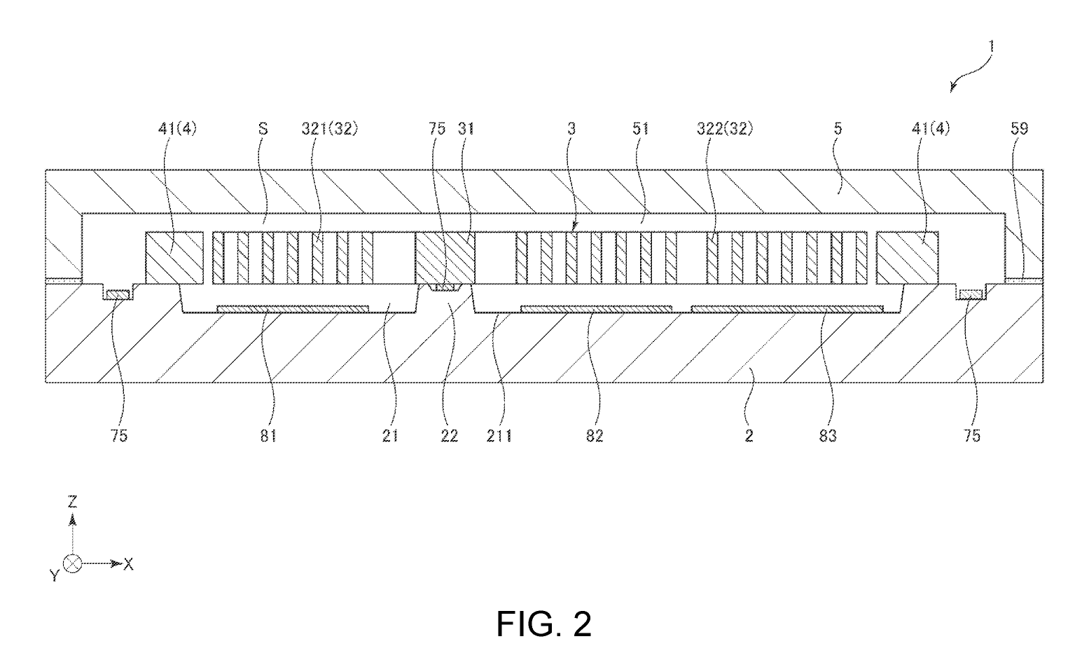

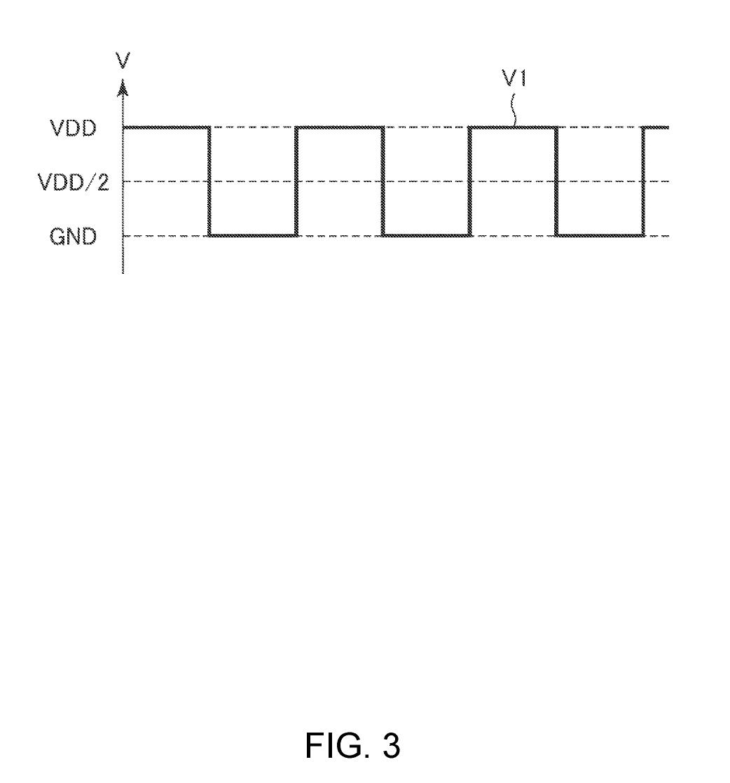

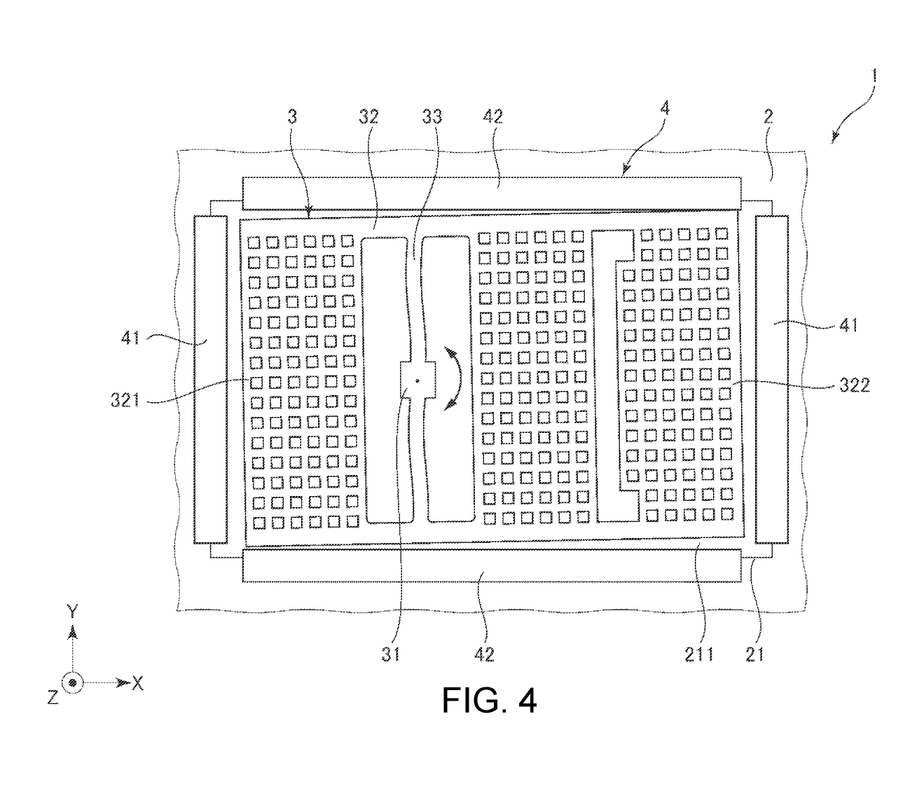

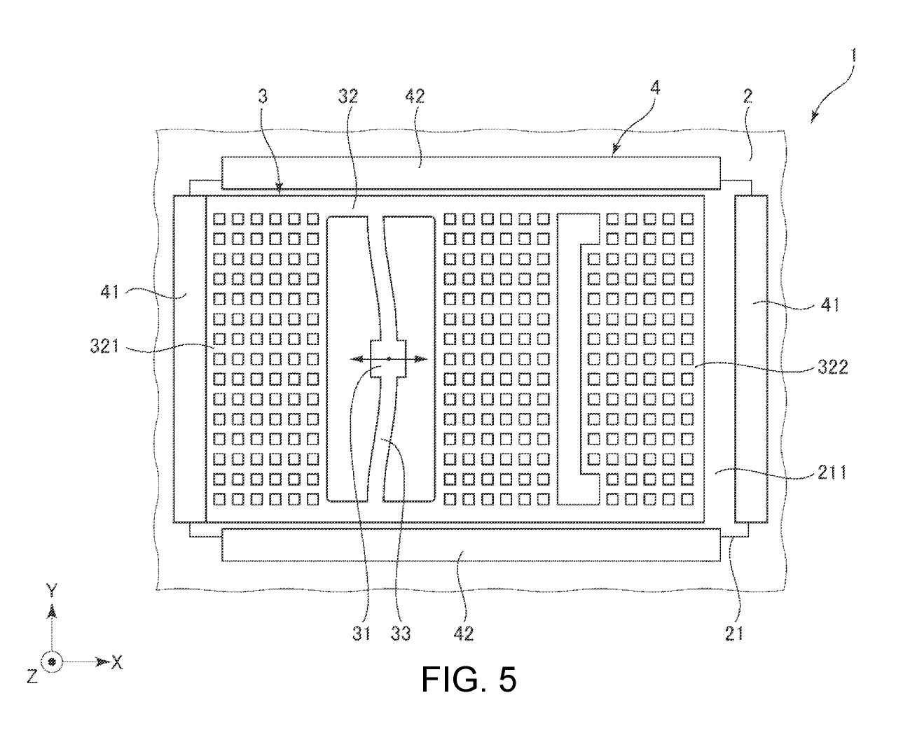

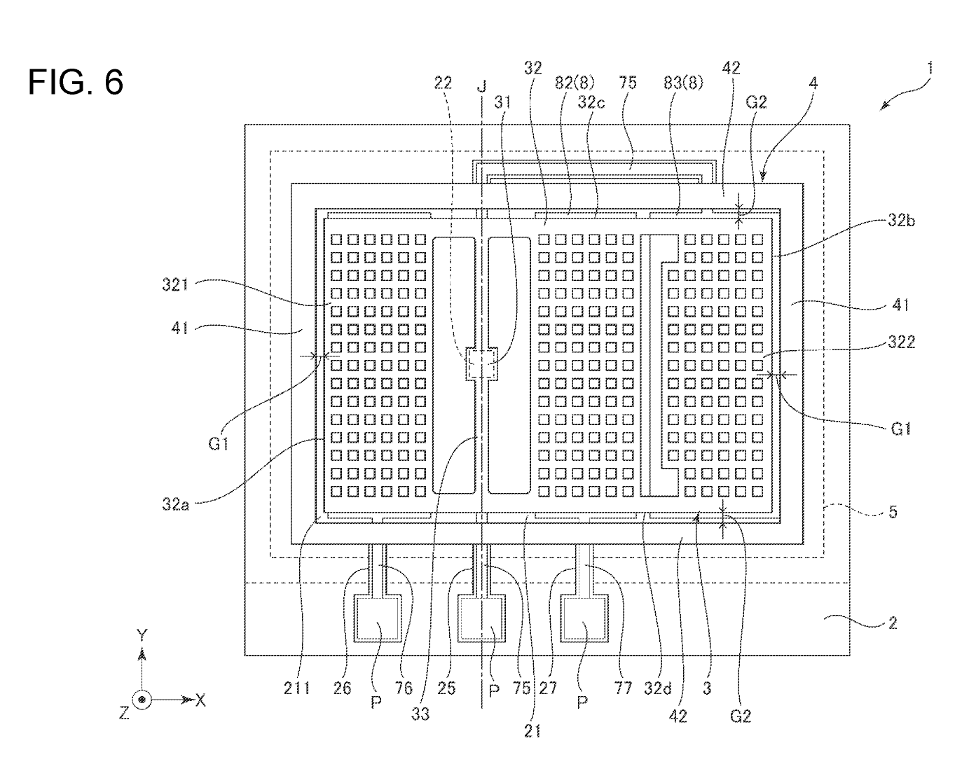

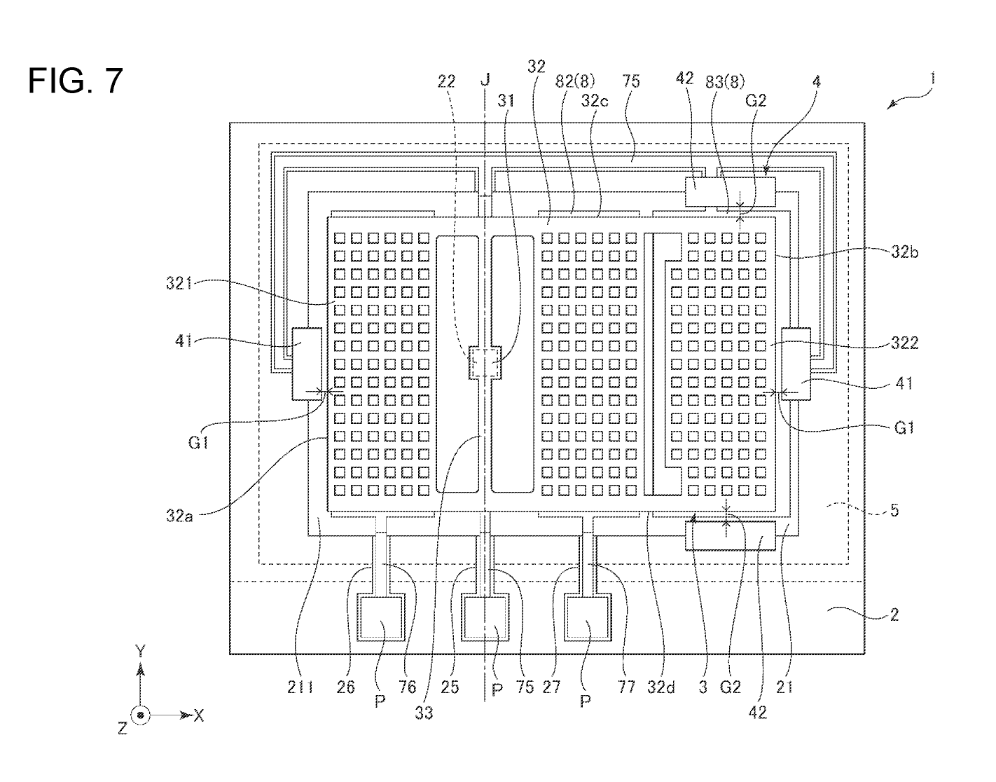

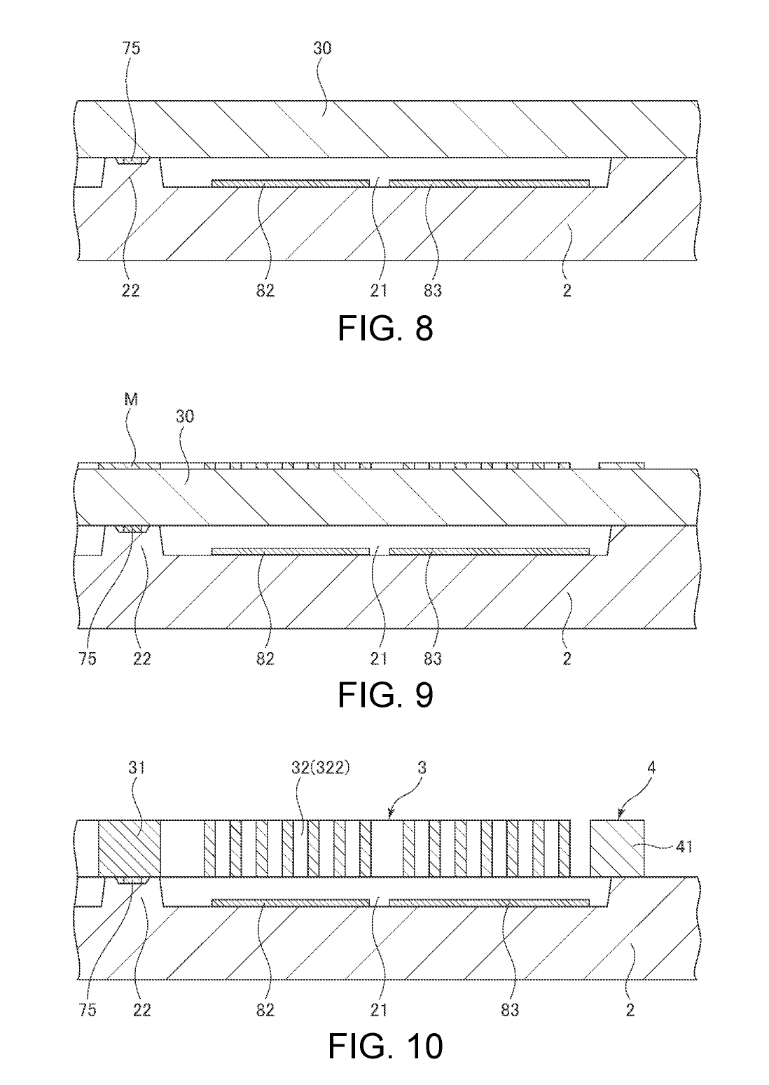

FIG. 1 is a plan view showing a physical quantity sensor according to a first embodiment. FIG. 2 is a cross-sectional view taken along the line A-A in FIG. 1. FIG. 3 is a diagram showing a voltage applied to the physical quantity sensor shown in FIG. 1. FIG. 4 is a plan view showing a torsional vibration mode of an element assembly shown in FIG. 1. FIG. 5 is a plan view showing an X-axis vibration mode of the element assembly shown in FIG. 1. FIGS. 6 and 7 are plan views showing a modification example of a displacement regulating portion, respectively. FIGS. 8 to 10 are sectional views showing a method of manufacturing the element assembly shown in FIG. 1, respectively. Hereinafter, for convenience of description, it is assumed that three mutually orthogonal axes are referred to as an X axis, a Y axis and a Z axis, the direction parallel to the X axis is an “X-axis direction”, the direction parallel to the Y axis is a “Y-axis direction”, and the direction parallel to the Z axis are also referred to as a “Z-axis direction”. In addition, the leading side in the arrow direction to each axis is also called “plus side”, and the opposite side is also called “minus side”. In addition, the plus side in the Z axis direction is also referred to as “upper”, and the minus side in the Z axis direction is also referred to as “lower”.

In addition, in the specification of the present application, the term “orthogonal” includes not only a case where axes intersect at 90° but also a case where axes intersect at an angle slightly inclined from 90° (for example, about)90°±10°. Specifically, the case where the X axis is inclined by ±10° with respect to the normal direction to a YZ plane, the case where the Y axis is inclined by ±10° with respect to the normal direction to an XZ plane, and the case where the Z axis is inclined by ±10° with respect to the normal direction to an XY plane are also included in “orthogonal”.

A physical quantity sensor 1 shown in FIG. 1 is an acceleration sensor capable of measuring an acceleration Az in the Z axis direction. Such the physical quantity sensor 1 includes a substrate 2, an element assembly 3 and a displacement regulating portion 4 disposed on the substrate 2, and a lid 5 joined to the substrate 2 so as to cover the element assembly 3 and the displacement regulating portion 4. Hereinafter, each of these portions will be described in detail in order.

### Substrate

As shown in FIG. 1, the substrate 2 has a plate shape having a rectangular plan view shape. In addition, the substrate 2 has a recessed portion 21 which opens to the upper surface side. Further, in a plan view in the Z-axis direction (normal direction to the substrate 2), the recessed portion 21 is formed larger than the element assembly 3 so as to enclose the element assembly 3 inside. Such the recessed portion 21 functions as a clearance portion for preventing the contact between the element assembly 3 and the substrate 2.

In addition, the substrate 2 has a projecting mount portion 22 provided on a bottom surface 211 of the recessed portion 21. The element assembly 3 is joined to the upper surface of the mount portion 22. Thereby, the element assembly 3 may be fixed to the substrate 2 in a state of being separated from the bottom surface 211 of the recessed portion 21. In addition, as shown in FIG. 1, the substrate 2 has grooves 25, 26, and 27 which open to the upper surface side.

As the substrate 2, for example, a glass substrate made of a glass material (for example, borosilicate glass such as Pyrex glass (registered trademark), Tempax glass (registered trademark)) containing alkali metal ions (movable ions such as Na+) may be used. However, the substrate 2 is not particularly limited, and for example, a silicon substrate or a ceramic substrate may be used. In a case where a silicon substrate is used as the substrate 2, from the viewpoint of preventing a short circuit, it is preferable to use a high resistance silicon substrate or a silicon substrate having a silicon oxide film (insulating oxide) formed on the surface thereof by thermal oxidation or the like.

In addition, as shown FIGS. 1 and 2, a first fixed electrode 81, a second fixed electrode 82, and a dummy electrode 83 as an electrode 8 are arranged apart from each other on the bottom surface 211 of the recessed portion 21.

In addition, as shown in FIG. 1, wirings 75, 76, and 77 are provided in the grooves 25, 26, and 27. One end portions of the wirings 75, 76, and 77 are exposed to the outside of the lid 5, respectively and function as electrode pads P that make electrical connection with external devices. In addition, as shown in FIG. 2, the wiring 75 is routed to the mount portion 22 and is electrically connected to the element assembly 3 (a fixed portion 31) on the mount portion 22. In addition, the wiring 75 is also electrically connected to the dummy electrode 83. In addition, the wiring 76 is electrically connected to the first fixed electrode 81, and the wiring 77 is electrically connected to the second fixed electrode 82.

### Lid

As shown in FIG. 1, the lid 5 has a plate shape having a rectangular plan view shape. In addition, as shown in FIG. 2, the lid 5 has a recessed portion 51 that opens in the lower surface side (substrate 2 side). Such the lid 5 is joined to the upper surface of the substrate 2 so as to accommodate the element assembly 3 and the displacement regulating portion 4 in the recessed portion 51. A storage space S for accommodating the element assembly 3 and the displacement regulating portion 4 is formed inside the lid 5 and the substrate 2.

The storage space S is an airtight space. In addition, it is preferable that the storage space S is substantially at atmospheric pressure at an operating temperature (about −40° C. to about 120° C.) with an inert gas such as nitrogen, helium, argon or the like sealed therein. By setting the storage space S at the atmospheric pressure, viscous resistance is increased and damping effect is exerted, and the vibration of the element assembly 3 may be promptly converged. Therefore, the detection accuracy of the acceleration of the physical quantity sensor 1 is improved. However, the atmosphere of the storage space S is not particularly limited and may be in, for example, a negative pressure state (reduced pressure state) or a positive pressure state (pressurized state).

As the lid 5, for example, a silicon substrate may be used. However, the lid 5 is not particularly limited, and for example, a glass substrate or a ceramic substrate may be used. In addition, the method of joining the substrate 2 and the lid 5 is not particularly limited and may be appropriately selected depending on the materials of the substrate 2 and the lid 5. For example, anodic bonding, activation bonding for bonding the bonding surfaces activated by plasma irradiation, bonding with a bonding material such as glass frit, and diffusion bonding for bonding the metal films formed on the upper surface of the substrate 2 and the lower surface of the lid 5, or the like may be used. In the present embodiment, the substrate 2 and the lid 5 are joined via a glass frit 59 (low melting point glass).

### Element Portion

As shown in FIG. 1, the element assembly 3 has the fixed portion 31 joined to the upper surface of the mount portion 22, a movable member 32 displaceable with respect to the fixed portion 31, and a beam 33 connecting the fixed portion 31 and the movable member 32. Then, when the acceleration Az acts, the movable member 32 seesaws with respect to the fixed portion 31 while torsionally deforming the beam 33 with the beam 33 as a swing axis J.

Such the element assembly 3 may be formed by patterning a conductive silicon substrate doped with impurities such as phosphorus (P), boron (B), arsenic (As) or the like by etching (in particular, dry etching). In addition, the element assembly 3 is joined to the upper surface of the substrate 2 by anodic bonding. However, the material of the element assembly 3 and the bonding method of the element assembly 3 and the substrate 2 are not particularly limited.

The movable member 32 has a longitudinal shape (rectangular shape) extending in the X direction. A portion on the minus side (one side) in the X-axis direction with respect to the swing axis J is a first movable member 321, and a portion on the plus side (the other side) in the X-axis direction with respect to the swing axis J is a second movable member 322. In addition, the second movable member 322 is longer in the X-axis direction (mass is larger) than the first movable member 321, and the rotational moment (torque) of the second movable member 322 when the acceleration Az is applied is larger than that in the first movable member 321. Due to the difference in the rotational moment, when the acceleration Az is applied, the movable member 32 seesaws around the swing axis J.

In addition, the movable member 32 has an opening 323 between the first movable member 321 and the second movable member 322, and the fixed portion 31 and the beam 33 are disposed in the opening 323. By adopting such a shape, it is possible to downsize the element assembly 3. In addition, the beam 33 extends along the Y-axis direction and forms the swing axis J. However, the disposition of the fixed portion 31 and the beam 33 is not particularly limited and may be located outside the movable member 32, for example.

Returning to the description of the electrode 8, the first fixed electrode 81 is disposed to be opposed to the first movable member 321 in a plan view in the Z-axis direction (a plan view in the normal direction to the substrate 2), and the second fixed electrode 82 is disposed to be opposed to the second movable member 322. When the physical quantity sensor 1 is driven, for example, a voltage V1 shown in FIG. 3 is applied to the element assembly 3, and the first fixed electrode 81 and the second fixed electrode 82 are connected to a QV amplifier (charge voltage conversion circuit), respectively. Therefore, an electrostatic capacitance Ca is formed between the first fixed electrode 81 and the first movable member 321, and an electrostatic capacitance Cb is formed between the second fixed electrode 82 and the second movable member 322.

When the acceleration Az is applied to the physical quantity sensor 1, due to the difference in the rotational moment of the first and second movable members 321 and 322, the movable member 32 seesaws around the swing axis J while twisting the beam 33 torsionally. The gap between the first movable member 321 and the first fixed electrode 81 and the gap between the second movable member 322 and the second fixed electrode 82 are changed by the seesaw motion of the movable member 32, and the electrostatic capacitances Ca and Cb change, respectively. Therefore, according to the physical quantity sensor 1, it is possible to detect the acceleration Az based on the amount of change in the electrostatic capacitances Ca and Cb.

As shown in FIGS. 1 and 2, the dummy electrode 83 is disposed so as to be opposed to a portion of the second movable member 322 on the leading side (the side far from the swing axis J) in the plan view in the Z-axis direction. As described above, the dummy electrode 83 is electrically connected to the wiring 75 and has the same potential as the movable member 32. An unintentional electrostatic attractive force is generated between the bottom surface 211 of the recessed portion 21 and the second movable member 322, and the dummy electrode 83 is provided in order to reduce the output drift caused by the swing of the movable member 32 by the electrostatic attractive force.

The configuration of the element assembly 3 has been described above. The element assembly 3 has a plurality of vibration modes (unnecessary vibration modes other than the detection vibration mode) besides the vibration mode (hereinafter, this vibration is also referred to as “detection vibration mode”) that seesaws around the swing axis J. As a vibration mode other than the detection vibration mode as described above, for example, there are a torsional vibration mode (first vibration mode) in which the movable member 32 rotates and vibrates around the Z axis about the fixed portion 31 while elastically deforming the beam 33 as shown in FIG. 4 and an X axis vibration mode (second vibration mode) in which the movable member 32 vibrates in the X-axis direction while elastically deforming the beam 33 as shown in FIG. 5.

For example, when the physical quantity sensor freely falls (environment in which external forces varying with time are working), vibrations of various frequencies are applied, and therefore the torsional vibration mode and the X-axis vibration mode are excited together with the detection vibration mode. When unnecessary vibrations (vibrations other than vibration around the swing axis J) of the movable member 32 due to the torsional vibration mode, the X axis vibration mode, or the like occurs, the vibrations become noise and the detection accuracy of the acceleration Az decreases.

The relationship between the resonance frequencies of the detection vibration mode, the torsional vibration mode, and the X-axis vibration mode is not particularly limited, but in the present embodiment, when the resonance frequency of the detection vibration mode is f1, the resonance frequency of the torsional vibration mode is f2, and the resonance frequency of the X-axis vibration mode is f3, the relationship is f1<f2<f3. Here, since the resonance frequency increases as the spring constant of the beam 33 increases, in the present embodiment, when the spring constant of the beam 33 in the detection vibration mode is k1, the spring constant of the beam 33 in the torsional vibration mode is k2, and the spring constant of the beam 33 in the X-axis vibration mode is k3, it may also be said that k1<k2<k3 is satisfied.

In addition, as the spring constant of the beam 33 decreases, the beam 33 becomes soft and easily deformed, the displacement amount (amplitude) of the movable member 32 increases. That is, in the case of the present embodiment, among the unnecessary vibration modes, the displacement amount (amplitude) of the movable member 32 is larger in the torsional vibration mode than in the X-axis vibration mode.

### Displacement Regulating Portion

The displacement regulating portion 4 (structure body) is located on the periphery of the element assembly 3 and has a function of suppressing breakage of the element assembly 3 by regulating the above-described excessive displacement of the element assembly 3. As shown in FIG. 1, the displacement regulating portion 4 has at least one first regulating portion 41 (a first structure body) and at least one second regulating portion 42 (a second structure body) that are fixed to the substrate 2.

The first regulating portion 41 is located on the plus side and the minus side of the movable member 32 in the X-axis direction and is provided in pairs with the movable member 32 interposed therebetween. In addition, in a natural state (a state in which no acceleration is applied), the pair of first regulating portions 41 are disposed to be opposed to the movable member 32 via a first gap G1, respectively. In addition, each of the pair of first regulating portions 41 has an elongated shape extending along the Y-axis direction so as to extend along outer edges 32a and 32b located at the end portion in the X-axis direction to the movable member 32. By contacting the movable member 32, the first regulating portion 41 functions as a stopper for regulating the displacement of the movable member 32 in the above-described X-axis vibration mode (see FIG. 5).

In the embodiment, the first gap G1 of the first regulating portion 41 located on the plus side of the movable member 32 in the X-axis direction and the first gap G1 of the first regulating portion 41 located on the minus side of the movable member 32 in the X-axis direction are equal in length, but are not limited thereto and may be different from each other.

The second regulating portion 42 is located on the plus side and the minus side of the movable member 32 in the Y-axis direction and is provided in pairs with the movable member 32 interposed therebetween. In addition, in a natural state (a state in which no acceleration is applied), the pair of second regulating portions 42 are disposed to be opposed to the movable member 32 via a second gap G2, respectively. In addition, each of the pair of second regulating portions 42 has an elongated shape extending along the X-axis direction so as to extend along outer edges 32c and 32d located at the end portion in the Y-axis direction to the movable member 32. By contacting the movable member 32, the second regulating portion 42 functions as a stopper for regulating the displacement of the movable member 32 in the above-described torsional vibration mode (see FIG. 4).

In the embodiment, the second gap G2 of the second regulating portion 42 located on the plus side of the movable member 32 in the Y-axis direction and the second gap G2 of the second regulating portion 42 located on the minus side of the movable member 32 in the Y-axis direction are equal in length, but are not limited thereto and may be different from each other.

Such the first regulating portion 41 and the second regulating portion 42 may be formed by patterning a conductive silicon substrate doped with impurities such as phosphorus (P), boron (B), arsenic (As) or the like by etching (in particular, dry etching). In addition, the first regulating portion 41 and the second regulating portion 42 are joined to the upper surface of the substrate by anodic bonding. In particular, in the present embodiment, by etching the conductive silicon substrate joined to the substrate 2, the element assembly 3 and the displacement regulating portion 4 are collectively formed from the silicon substrate. Thereby, it is possible to simplify the manufacturing process of the physical quantity sensor 1. However, the materials of the first regulating portion 41 and the second regulating portion 42 and the joining method between the first regulating portion 41 and the second regulating portion 42 and the substrate 2 are not particularly limited.

In the present embodiment, the first regulating portion 41 and the second regulating portion 42 are separately disposed, but the present disclosure is not limited thereto, for example, as shown in FIG. 6, these portions may be integrated. That is, the displacement regulating portion 4 may have a frame shape surrounding the element assembly 3. In addition, the first regulating portion 41 has substantially the same length as the width (length in Y-axis direction) of the movable member 32 and is opposed to the entire area of the outer edges 32a and 32b of the movable member 32, but the present disclosure is not limited thereto. For example, as shown in FIG. 7, the length of the first regulating portion 41 may be shorter than the width of the movable member 32 and may be opposed to a portion (the central portion in FIG. 7) of the outer edges 32a and 32b of the movable member 32. Similarly, the second regulating portion 42 has substantially the same length as the length (X-axis direction length) of the movable member 32 and is opposed to the entire area of the outer edges 32c and 32d of the movable member 32, but the present disclosure is not limited thereto. For example, as shown in FIG. 7, the length of the second regulating portion 42 may be shorter than the length of the movable member 32 and may be opposed to a part (the end portion on the plus side in the X-axis direction where the amount of displacement in the Y-axis direction is the largest in the torsional vibration mode) of the outer edges 32c and 32d of the movable member 32. In addition, one of the pair of first regulating portions 41 may be omitted or one of the pair of second regulating portions 42 may be omitted.

In addition, the first regulating portion 41 and the second regulating portion 42 are electrically connected to the wiring 75, respectively, and have the same potential as the movable member 32. Thereby, an electrostatic attractive force is generated between the movable member 32 and the first regulating portion 41 and between the movable member 32 and the second regulating portion 42, and it is possible to suppress the movable member 32 from being unintentionally displaced. Therefore, the physical quantity sensor 1 is capable of detecting the acceleration Az more accurately. However, the present disclosure is not limited thereto, and for example, the first regulating portion 41 and the second regulating portion 42 may be connected to ground (GND). As a result, the first regulating portion 41 and the second regulating portion 42 function as shield electrodes, and it is possible to effectively block disturbance noise. Therefore, the physical quantity sensor 1 is capable of detecting the acceleration Az more accurately.

Here, as described above, in the present embodiment, since the resonance frequency f2 of the torsional vibration mode is lower than the resonance frequency f3 of the X-axis vibration mode (f2<f3), in the torsional vibration mode, the movable member 32 is more likely to move than in the X-axis vibration mode and the displacement amount (amplitude) thereof is also large. Therefore, in the physical quantity sensor 1, the first regulating portion 41 for regulating the X-axis vibration mode which is difficult to move (small amount of displacement) is disposed closer to the movable member 32, and the second regulating portion 42 for regulating the torsional vibration mode which is more easily movable than the X-axis vibration mode is disposed farther from the movable member 32 than the first regulating portion 41. That is, the first gap G1 which is the gap between the first regulating portion 41 and the movable member 32 is made smaller than the second gap G2 which is the gap between the second regulating portion 42 and the movable member 32. In this manner, the torsional vibration mode and the X-axis vibration mode may be regulated in a well-balanced way by changing the first gap G1 and the second gap G2 according to the amount of displacement amount. Only for the purpose of regulating unnecessary vibrations of the movable member 32, it is also preferable to make the second gap G2 as small as the first gap G1, but in the embodiment, it is intentionally designed to satisfy the relationship of G1<G2 for the reasons described below.

By setting the relationship G1<G2 as described above, displacement in the vibration mode different from the detection vibration mode of the movable member 32 may be suppressed, and an excellent acceleration detection characteristic may be obtained. Specifically, as described above, since the movable member 32 is more likely to be displaced around the Z axis (that is, the Y-axis direction) than the X-axis direction, it is possible to effectively regulate the displacement of the movable member 32 which is easy to move in the Y-axis direction and the displacement of the movable member 32 which is difficult to move in the X-axis direction by setting G1<G2. Therefore, noise is reduced, and the acceleration Az may be detected with higher accuracy.

In addition, the manufacturing load of the element assembly 3 may be reduced by setting the relationship of G1<G2. Here, a method of manufacturing the element assembly 3 will be briefly described. First, as shown in FIG. 8, the silicon substrate 30 is joined to the upper surface of the substrate 2. Next, as shown in FIG. 9, a mask M (hard mask) corresponding to the shapes of the element assembly 3 and the displacement regulating portion 4 is disposed on the upper surface of the silicon substrate 30. Next, as shown in FIG. 10, the silicon substrate 30 is dry-etched (in particular, Bosch process) through the mask M, whereby the element assembly 3 and the displacement regulating portion 4 are collectively formed from the silicon substrate 30.

Here, in dry etching, as the opening of the mask M is narrower, the reactive gas hardly intrudes and the etching rate decreases. Therefore, if the opening of the mask M is narrow, the etching time is prolonged, the manufacturing load is increased, other portions are etched (over-etching) more than necessary, and there is a possibility that shape deviation from a desired shape is caused. Therefore, regarding the second regulating portion 42 that regulates the displacement of the movable member 32 in the Y-axis direction, which is easy to move so that the portion where the opening of the mask M is as narrow as possible, the gap (second gap G2) with the movable member 32 is not reduced to the same extent as the first gap G1 but larger than the first gap G1. As a result, as compared with the case of G1≥G2, the area where the opening of the mask M is narrow is reduced, and the manufacturing load of the element assembly 3 may be reduced accordingly.

That is, the physical quantity sensor 1 more effectively regulates the displacement of the movable member 32, which is hard to move, in the X-axis direction to increase detection accuracy of acceleration Az by disposing the first regulating portion 41 as close to the movable member 32 as possible while reducing the displacement of the movable member 32 in the Y-axis direction and reducing the manufacturing load of the element assembly 3 by disposing the second regulating portion 42 farther from the movable member 32 within a range in which the function thereof. According to such a physical quantity sensor 1, it is possible to suppress displacement different from the detection vibration of the movable member 32 and to reduce the manufacturing load. It suffices that the relation of G1<G2 is satisfied, but 5G1≤G2≤20G1 is preferable, and 10G1≤G2≤20G1 is more preferable. Thereby, the above-described effect may be exerted more remarkably.

The first gap G1 is not particularly limited and also varies depending on the thickness of the element assembly 3, but for example, when the thickness of the element assembly 3 is about 30 μm, it is preferable that the second gap G2 is 0.5 μm or more and 2 μm or less. Thereby, it is possible to make the first gap G1 narrow sufficient to regulate the displacement of the movable member 32 in the X-axis direction and to prevent the etching time for forming the first gap G1 from becoming excessively long. In the embodiment, the first regulating portion 41 extends in the Y-axis direction along the movable member 32, and the first gap G1 is constant along the Y-axis direction, but the present disclosure is not limited thereto, and the first gap G1 may be changed along the Y-axis direction. In this case, the first gap G1 refers to the minimum value of the first gap G1, for example.

In addition, the second gap G2 is not particularly limited and varies depending on the size of the movable member 32. However, for example, in a case where the length (length in X axis direction) is about 800 μm and the width (length in the Y-axis direction) is about 450 μm, it is preferable that the first gap G1 is 8 μm or more and 12 μm or less. Thereby, it is possible to make the first gap G1 sufficient for regulating the displacement of the movable member 32 around the Z axis (Y-axis direction), and to make the second gap G2 larger. In the embodiment, the second regulating portion 42 extends in the X-axis direction along the movable member 32, and the second gap G2 is constant along the X-axis direction, but the present disclosure is not limited thereto, and the second gap G2 may be changed along the X-axis direction. In this case, the second gap G2 is, for example, a gap (separation distance in the Y-axis direction) between the position (in the embodiment, both corner portions located on the plus side in the X-axis direction) where the displacement amount around the Z axis of the movable member 32 is the largest and the second regulating portion 42.

The physical quantity sensor 1 has been described above. As described above, such the physical quantity sensor 1 includes the substrate 2, the fixed portion 31 fixed to the substrate 2, the movable member 32 displaceable with respect to the fixed portion 31, the element assembly 3 having the beam 33 connecting the fixed portion 31 and the movable member 32, and the displacement regulating portion 4 (structure body) that is located on the periphery of the movable member 32 in the plan view in the Z-axis direction (normal direction to the substrate 2). In addition, the displacement regulating portion 4 includes the first regulating portion 41 (first structure body) that is arranged in the X-axis direction (first direction) with the movable member 32 and provided on the substrate 2 via the movable member 32 and the first gap G1 in the plan view in the Z-axis direction, the second regulating portion 42 (second structure body) that is arranged in the Y-axis direction (second direction) orthogonal to the movable member 32 in the X-axis direction and provided on the substrate 2 via the second gap G2 larger than the movable member 32 and the first gap G1 in the plan view in the Z-axis direction. The spring constant k2 of the beam 33 when the movable member 32 is displaced around the Z axis (the axis along the Z-axis direction (third direction) orthogonal to the X-axis direction and the Y-axis direction) is smaller than the spring constant k3 when the movable member 32 is displaced in the X-axis direction. Therefore, as described above, the physical quantity sensor 1 capable of suppressing the displacement in the vibration mode different from the detection vibration mode of the movable member 32 is realized by the first regulating portion 41 and the second regulating portion 42 and obtaining an excellent acceleration detection characteristic. In addition, the area where the opening of the mask M for etching is narrow is reduced, and the manufacturing load of the element assembly 3 may be reduced accordingly.

Further, in other words, the physical quantity sensor 1 includes the substrate 2, the fixed portion 31 fixed to the substrate 2, the movable member 32 displaceable with respect to the fixed portion 31, the element assembly 3 having the beam 33 connecting the fixed portion 31 and the movable member 32, and the displacement regulating portion 4 (structure body) that is located on the periphery of the movable member 32 in the plan view in the Z-axis direction (normal direction to the substrate 2). In addition, the displacement regulating portion 4 includes the first regulating portion 41 (first structure body) that is arranged in the X-axis direction (first direction) with the movable member 32 and provided on the substrate 2 via the movable member 32 and the first gap G1 in the plan view in the Z-axis direction, the second regulating portion 42 (second structure body) that is arranged in the Y-axis direction (second direction) orthogonal to the movable member 32 in the X-axis direction and provided on the substrate 2 via the second gap G2 larger than the movable member 32 and the first gap G1 in the plan view in the Z-axis direction. Then, the element assembly 3 has the torsional vibration mode (first vibration mode) that vibrates around the Z axis (the axis along the Z axis direction (the third direction) orthogonal to the X-axis direction and the Y-axis direction), and the X-axis vibration mode that vibrates in the X-axis direction and has a higher resonance frequency than the torsional vibration mode (a second vibration mode). Therefore, as described above, the physical quantity sensor 1 capable of suppressing the displacement in the vibration mode different from the detection vibration mode of the movable member 32 is realized by the first regulating portion 41 and the second regulating portion 42 and obtaining an excellent acceleration detection characteristic. In addition, the area where the opening of the mask M for etching is narrow is reduced, and the manufacturing load of the element assembly 3 may be reduced accordingly.

In addition, as described above, the movable member 32 includes the first movable member 321 located on one side of the swing axis J via the swing axis J, and the second movable member 322 located on the other side and whose rotational moment around the swing axis J is different from the rotational moment of the first movable member 321. In addition, the physical quantity sensor 1 includes the first fixed electrode 81 disposed on the substrate 2 and opposed to the first movable member 321, the second fixed electrode 82 disposed on the substrate 2 and opposed to the second movable member 322. Then, when the acceleration Az is applied in the Z-axis direction (normal direction to the substrate 2), the movable member 32 swings around the swing axis J while torsionally deforming the beam 33. Thereby, the acceleration Az may be detected based on the electrostatic capacitance between the first movable member 321 and the first fixed electrode 81 and the electrostatic capacitance between the second movable member 322 and the second fixed electrode 82. In addition, with this configuration, unnecessary vibrations (torsional vibration mode and X-axis vibration mode) other than detection vibration are vibrations into the plane of the movable member 32 while the detection vibration is a vibration outside the plane of the movable member 32. Therefore, only the unnecessary vibrations may be effectively regulated by the first regulating portion 41 and the second regulating portion 42 disposed on the periphery of the movable member 32 without hindering the detection vibration.

In addition, as described above, the first regulating portion 41 is provided on both sides (plus side and minus side) of the movable member 32 in the X axis direction. That is, the pair of first regulating portions are disposed so as to sandwich the movable member 32 therebetween. Thereby, it is possible to regulate the displacement of the movable member 32 toward the plus side in the X axis direction and the displacement toward the minus side in the X axis direction and to effectively regulate the displacement of the movable member 32 in the X-axis vibration mode.

In addition, as described above, the second regulating portion 42 is provided on both sides of the movable member 32 in the Y-axis direction. That is, the pair of second regulating portions 42 are disposed so as to sandwich the movable member 32 therebetween. Thereby, it is possible to regulate the displacement of the movable member 32 toward the one side around the Z axis of the movable member 32 and the displacement toward the other side around the Z axis and to effectively regulate the displacement of the movable member 32 in the torsional vibration mode.

In addition, as described above, at least one (both in the embodiment) of the first regulating portion 41 and the second regulating portion 42 is at the same potential as the movable member 32. Thereby, an electrostatic attractive force is generated between the movable member 32 and the first regulating portion 41 and between the movable member 32 and the second regulating portion 42, and it is possible to suppress the movable member 32 from being unintentionally displaced. Therefore, the physical quantity sensor 1 is capable of detecting the acceleration Az more accurately.

### Second Embodiment

Next, a physical quantity sensor device according to a second embodiment will be described.

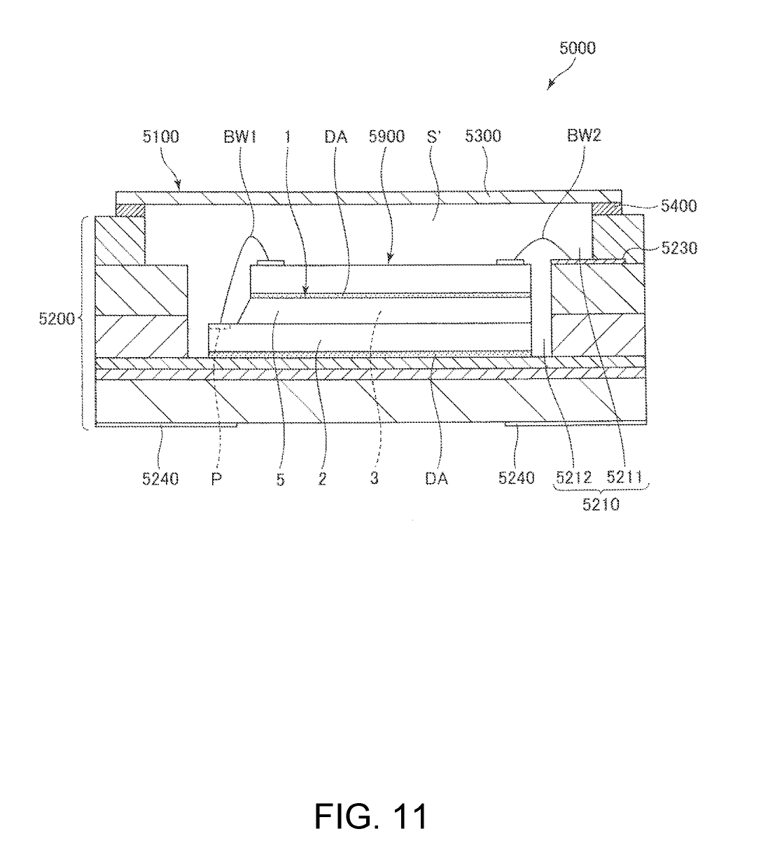

FIG. 11 is a cross-sectional view showing a physical quantity sensor device according to a second embodiment.

As shown in FIG. 11, a physical quantity sensor device 5000 includes a physical quantity sensor 1, a semiconductor element 5900 (circuit element), and a package 5100 that stores the physical quantity sensor 1 and the semiconductor element 5900. As the physical quantity sensor 1, for example, any of the above-described first embodiment may be used.

The package 5100 has a cavity-shaped base 5200 and a lid 5300 joined to the upper surface of the base 5200. The base 5200 has a recessed portion 5210 that opens on the upper surface thereof. In addition, the recessed portion 5210 has a first recessed portion 5211 that opens on the upper surface of the base 5200 and a second recessed portion 5212 that opens on the bottom surface of the first recessed portion 5211.

On the other hand, the lid 5300 is plate-shaped and is joined to the upper surface of the base 5200 so as to close the opening of the recessed portion 5210. In this manner, by closing the opening of the recessed portion 5210 with the lid 5300, a storage space S′ is formed in the package 5100, and the physical quantity sensor 1 and the semiconductor element 5900 are stored in the storage space S′. The method of joining the base 5200 and the lid 5300 is not particularly limited, and seam welding via a seam ring 5400 is used in the embodiment.

The storage space S′ is hermetically sealed. The atmosphere of the storage space S′ is not particularly limited, but preferably the same atmosphere as the storage space S of the physical quantity sensor 1, for example. Thereby, even if the airtightness of the storage space S breaks and the storage spaces S and S′ communicate with each other, the atmosphere in the storage space S may be maintained as it is. Therefore, it is possible to suppress a change in the detection characteristic of the physical quantity sensor 1 due to a change in the atmosphere of the storage space S, and to obtain a stable detection characteristic.

The constituent material of the base 5200 is not particularly limited, and various ceramics such as alumina, zirconia, titania and the like may be used, for example. In addition, the constituent material of the lid 5300 is not particularly limited, but may be a member having a linear expansion coefficient close to that of the constituent material of the base 5200. For example, in a case where the constituent material of the base 5200 is ceramics as described above, it is preferable to use an alloy such as Kovar.

The base 5200 has a plurality of internal terminals 5230 disposed in the storage space S′ (the bottom surface of the first recessed portion 5211) and a plurality of external terminals 5240 disposed on the bottom surface. Each of the internal terminals 5230 is electrically connected to a predetermined external terminal 5240 via an internal wiring (not shown) disposed in the base 5200.

The physical quantity sensor 1 is fixed to the bottom surface of the recessed portion 5210 via a die attach material DA (joining member). Further, the semiconductor element 5900 is disposed on the upper surface of the physical quantity sensor 1 via the die attach material DA. The physical quantity sensor 1 and the semiconductor element 5900 are electrically connected via a bonding wire BW1, and the semiconductor element 5900 and the internal terminal 5230 are electrically connected via a bonding wire BW2.

In addition, in the semiconductor element 5900, for example, a drive circuit for applying a drive voltage to the physical quantity sensor 1, a detection circuit for detecting the acceleration Az based on an output from the physical quantity sensor 1, and an output circuit for converting a signal from the detection circuit into a predetermined signal and outputting the signal, and the like are included as necessary.

The physical quantity sensor device 5000 has been described above. Such the physical quantity sensor device 5000 includes the physical quantity sensor 1 and a semiconductor element 5900 (circuit element) electrically connected to the physical quantity sensor 1. Therefore, it is possible to obtain the effect of the physical quantity sensor 1 and to obtain the physical quantity sensor device 5000 with high reliability.

### Third Embodiment

Next, an electronic device according to a third embodiment will be described.

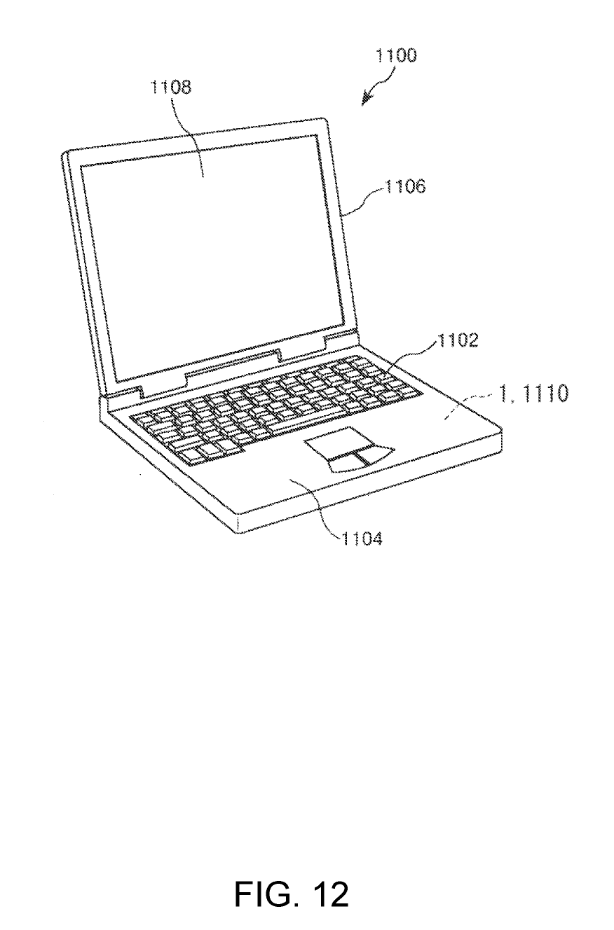

FIG. 12 is a perspective view showing an electronic device according to a third embodiment.

A mobile type (or notebook type) personal computer 1100 shown in FIG. 12 is one to which the electronic device according to the present disclosure is applied. The personal computer 1100 is configured by a main body 1104 having a keyboard 1102 and a display unit 1106 having a display portion 1108, and the display unit 1106 is rotatably supported relative to the main body 1104 via a hinge structure. In addition, the personal computer 1100 includes a physical quantity sensor 1 and a control circuit 1110 (control unit) that performs control based on detection signals output from the physical quantity sensor 1. As the physical quantity sensor 1, for example, any of the above-described embodiments may be used.

Such the personal computer 1100 (electronic device) includes the physical quantity sensor 1 and the control circuit 1110 (control unit) that performs control based on detection signals output from the physical quantity sensor 1. Therefore, it is possible to obtain the effect of the physical quantity sensor 1 described above and to obtain high reliability.

### Fourth Embodiment

Next, an electronic device according to a fourth embodiment will be described.

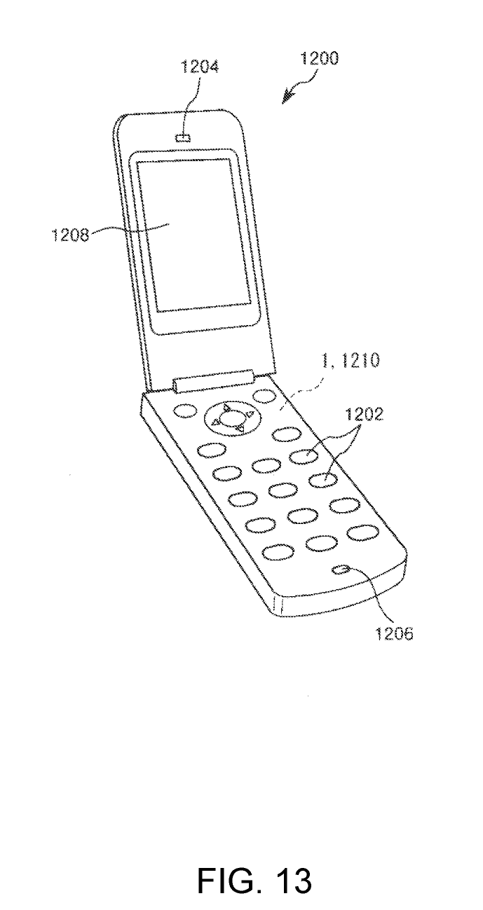

FIG. 13 is a perspective view showing the electronic device according to the fourth embodiment.

A mobile phone 1200 (including PHS) shown in FIG. 13 is one to which the electronic device according to the present disclosure is applied. The mobile phone 1200 includes an antenna (not shown), a plurality of operation buttons 1202, an earpiece 1204, and a mouthpiece 1206, and a display unit 1208 is disposed between the operation buttons 1202 and the earpiece 1204. In addition, the mobile phone 1200 includes a physical quantity sensor 1 and a control circuit 1210 (control unit) that performs control based on detection signals output from the physical quantity sensor 1.

Such the mobile phone 1200 (electronic device) includes the physical quantity sensor 1 and the control circuit 1210 (control unit) that performs control based on detection signals output from the physical quantity sensor 1. Therefore, it is possible to obtain the effect of the physical quantity sensor 1 described above and to obtain high reliability.

### Fifth Embodiment

Next, an electronic device according to a fifth embodiment will be described.

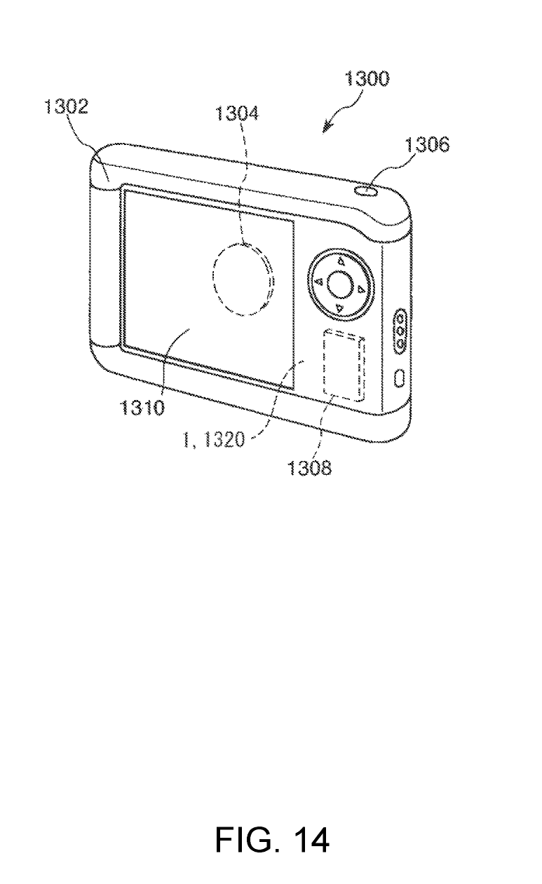

FIG. 14 is a perspective view showing the electronic device according to the fifth embodiment.

A digital still camera 1300 shown in FIG. 14 is one to which the electronic device according to the present disclosure is applied. The digital still camera 1300 includes a case 1302, and a display portion 1310 is provided on the back surface of the case 1302. The display portion 1310 is configured to perform display based on imaging signals of a CCD and functions as a finder that displays a subject as an electronic image. In addition, a light receiving unit 1304 including an optical lens (imaging optical system) and a CCD or the like is provided on the front side (back side in the drawing) of the case 1302.

When a photographer confirms the subject image displayed on the display portion 1310 and presses a shutter button 1306, the imaging signal of the CCD at that time is transferred and stored in a memory 1308. In addition, the digital still camera 1300 includes a physical quantity sensor 1 and a control circuit 1320 (control unit) that performs control based on detection signals output from the physical quantity sensor 1. The physical quantity sensor 1 is used for camera shake correction, for example.

Such the digital still camera 1300 (electronic device) includes the physical quantity sensor 1 and the control circuit 1320 (control unit) that performs control based on detection signals output from the physical quantity sensor 1. Therefore, it is possible to obtain the effect of the physical quantity sensor 1 described above and to obtain high reliability.

In addition to the personal computer and the mobile phone of the embodiments described above, and the digital still camera of the embodiment, the electronic device according to the present disclosure may be applied to, for example, a smartphone, a tablet terminal, a clock (including a smart watch), an ink jet type discharging device (for example, an ink jet printer), a laptop type personal computer, a television, a wearable terminal such as an head mounted display (HMD), a video camera, a video tape recorder, a car navigation device, a pager, an electronic notebook (including a communication function), an electronic dictionary, a calculator, an electronic game machine, a word processor, a workstation, a TV phone, a security TV monitor, electronic binoculars, a POS terminal, medical equipment (for example, electronic clinical thermometer, blood pressure monitor, blood glucose meter, electrocardiogram measuring device, ultrasonic diagnostic device, electronic endoscope), a fish finder, various measuring instruments, mobile terminal base station equipment, instruments (for example, instruments of vehicles, aircraft, ships), a flight simulator, a network server, and the like.

### Sixth Embodiment

Next, a vehicle according to a sixth embodiment will be described.

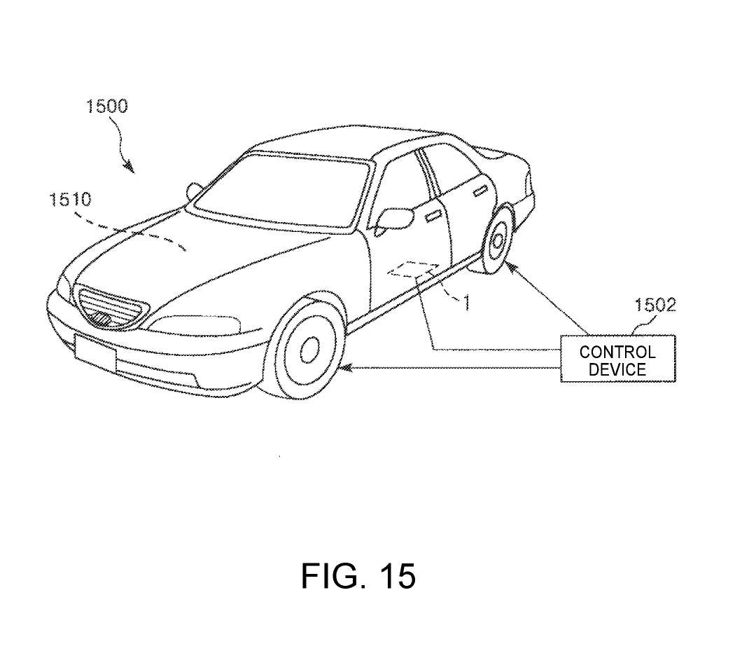

FIG. 15 is a perspective view showing the vehicle according to the sixth embodiment.

An automobile 1500 shown in FIG. 15 is a vehicle to which the vehicle according to the present disclosure is applied. In this figure, the automobile 1500 includes at least one system 1510 of an engine system, a brake system and a keyless entry system. In addition, a physical quantity sensor 1 is incorporated in the automobile 1500, and a detection signal of the physical quantity sensor 1 is supplied to a control device 1502, and the control device 1502 may control the system 1510 based on the signal.

Such the automobile 1500 (vehicle) includes the physical quantity sensor 1 and the control device 1502 (control unit) that performs control based on detection signals output from the physical quantity sensor 1. Therefore, it is possible to obtain the effect of the physical quantity sensor 1 described above and to obtain high reliability.

The physical quantity sensor 1 may also be widely applied to electronic control units (ECU) such as a car navigation system, a car air conditioner, an anti-lock braking system (ABS), an air bag, a tire pressure monitoring system (TPMS), an engine control, and a battery monitor of a hybrid vehicle or an electric vehicle.

In addition, the vehicle is not limited to the automobile 1500 but may also be applied to unmanned airplanes such as an airplane, a rocket, an artificial satellite, a ship, an automated guided vehicle (AGV), a biped walking robot, a drone, and the like.

The physical quantity sensor, the physical quantity sensor device, the electronic device, and the vehicle according to the present disclosure have been described based on the illustrated embodiments, but the present disclosure is not limited thereto, and the configuration of each portion may be replaced with an arbitrary configuration having the same function. In addition, any other constituent may be added to the present disclosure. Further, the above-described embodiments may be combined as appropriate.

In addition, in the above-described embodiment, the configuration in which the physical quantity sensor detects the acceleration in the Z-axis direction has been described, but the present disclosure is not limited thereto, and may be configured to detect the acceleration in the X-axis direction, or may be configured to detect the acceleration in the Y-axis direction. In addition, in the above-described embodiment, the configuration in which the physical quantity sensor detects an acceleration is described, but the physical quantity to be detected by the physical quantity sensor is not particularly limited and may be, for example, an angular velocity. That is, the physical quantity sensor may be a gyro sensor. In addition, the physical quantity sensor may be configured to be able to detect a plurality of physical quantities. The plurality of physical quantities may be the same kinds of physical quantity (for example, acceleration in the X-axis direction, acceleration in the Y-axis direction and acceleration in the Z-axis direction, angular velocity around the X axis, and the angular velocity around the Y axis and angular velocity around the Z axis) having different detection axes or may be different physical quantities (for example, angular velocity around the X axis and acceleration in the X-axis direction).

What is claimed is:

1. A physical quantity sensor comprising:
a substrate;
an element assembly that has a fixed portion which is fixed to the substrate, a movable member which is displaced with respect to the fixed portion, and a beam which connects the fixed portion and the movable member; and
a structure body that is provided on a periphery of the movable member and fixed to the substrate in a plan view in a normal direction to the substrate,
wherein the structure body includes
a first structure body in which the first structure body and the movable member are arranged in a first direction and which is separated from the movable member with a first gap therebetween, in the plan view, and
a second structure body in which the second structure body and the movable member are arranged in a second direction orthogonal to the first direction and which is separated from the movable member with a second gap larger than the first gap therebetween, in the plan view, and
a spring constant of the beam when the movable member is displaced around an axis along a third direction orthogonal to each of the first direction and the second direction is smaller than a spring constant of the beam when the movable member is displaced in the first direction.

2. A physical quantity sensor comprising:
a substrate;
an element assembly that has a fixed portion which is fixed to the substrate, a movable member which is capable of being displaced with respect to the fixed portion, and a beam which connects the fixed portion and the movable member; and
a structure body that is located on a periphery of the movable member in a plan view in a normal direction to the substrate,
wherein the structure body includes
a first structure body in which the first structure body and the movable member are arranged in a first direction and are provided on the substrate with first gap therebetween, in the plan view, and
a second structure body in which the second structure body and the movable member are arranged in a second direction orthogonal to the first direction and are provided on the substrate with a second gap larger than the first gap therebetween, in the plan view, and
the element assembly has
a first vibration mode that vibrates around an axis along a third direction orthogonal to each of the first direction and the second direction, and
a second vibration mode that vibrates in the first direction and has a resonance frequency higher than a resonance frequency of the first vibration mode.

3. The physical quantity sensor according to claim 1,
wherein the movable member includes a first movable member that is located on one side and a second movable member that is located on the other side with a swing axis interposed therebetween, the second movable member having a rotational moment around the swing axis different from a rotational moment around the swing axis of the first movable member,
the physical quantity sensor further comprises:
a first fixed electrode that is provided on the substrate and opposed to the first movable member; and
a second fixed electrode that is provided on the substrate and opposed to the second movable member, and
when an acceleration in the normal direction to the substrate is applied to the movable member, the movable member swings around the swing axis while torsionally deforming the beam.

4. The physical quantity sensor according to claim 1,
wherein the first structure body is provided on both sides of the movable member in the first direction.

5. The physical quantity sensor according to claim 1,
wherein the second structure body is provided on both sides of the movable member in the second direction.

6. The physical quantity sensor according to claim 1,
wherein at least one of the first structure body and the second structure body has the same potential as the movable member.

7. A physical quantity sensor device comprising:
the physical quantity sensor according to claim 1; and
a circuit element that is electrically connected to the physical quantity sensor.

8. A physical quantity sensor device comprising:
the physical quantity sensor according to claim 2; and
a circuit element that is electrically connected to the physical quantity sensor.

9. A physical quantity sensor device comprising:
the physical quantity sensor according to claim 3; and
a circuit element that is electrically connected to the physical quantity sensor.

10. A physical quantity sensor device comprising:
the physical quantity sensor according to claim 4; and
a circuit element that is electrically connected to the physical quantity sensor.

11. A physical quantity sensor device comprising:
the physical quantity sensor according to claim 5; and
a circuit element that is electrically connected to the physical quantity sensor.

12. An electronic device comprising:
the physical quantity sensor according to claim 1; and
a control unit that performs control based on a detection signal output from the physical quantity sensor.

13. An electronic device comprising:
the physical quantity sensor according to claim 2; and
a control unit that performs control based on a detection signal output from the physical quantity sensor.

14. An electronic device comprising:
the physical quantity sensor according to claim 3; and
a control unit that performs control based on a detection signal output from the physical quantity sensor.

15. An electronic device comprising:
the physical quantity sensor according to claim 4; and
a control unit that performs control based on a detection signal output from the physical quantity sensor.

16. An electronic device comprising:
the physical quantity sensor according to claim 5; and
a control unit that performs control based on a detection signal output from the physical quantity sensor.

17. A vehicle comprising:
the physical quantity sensor according to claim 1; and
a control unit that performs control based on a detection signal output from the physical quantity sensor.

18. A vehicle comprising:
the physical quantity sensor according to claim 2; and
a control unit that performs control based on a detection signal output from the physical quantity sensor.

19. A vehicle comprising:
the physical quantity sensor according to claim 3; and
a control unit that performs control based on a detection signal output from the physical quantity sensor.

20. A vehicle comprising:
the physical quantity sensor according to claim 4; and
a control unit that performs control based on a detection signal output from the physical quantity sensor.
